(19) United States
(12) Patent Application Publication
(10) Pub. No.: US 2025/0285803 A1
(43) Pub. Date: Sep. 11, 2025

(54) Inductive Filter Element

(71) Applicant: TDK Electronics AG, München (DE)

(72) Inventors: Tobias KORALEK, Ellwangen (Jagst) (DE); Felipe JEREZ GALDEANO, Thalfingen-Elchingen (DE); Anneliese DRESPLING, Heidenheim (DE)

(21) Appl. No.: 18/855,590

(22) PCT Filed: May 4, 2023
(86) PCT No.: PCT/EP2023/061803

§ 371 Date: Oct. 9, 2024

(30) Foreign Application Priority Data
May 6, 2022 (DE) 102022111363.9

(51) Int. Cl. H01F 27/30; H01F 17/04; H01F 27/02; H01F 27/24; H01F 27/28

(52) U.S. Cl. CPC H01F 27/306; H01F 17/04; H01F 27/24; H01F 27/2823; H01F 27/02

(57) ABSTRACT

An inductive filter element is specified that comprises a core element comprising a first end region, a central region, and a second end region arranged along a longitudinal direction. The central region is arranged between the first end region and the second end region. A wire comprising a winding part is formed as a winding on the central region of the core element. The central region of the core element has a length lc in the longitudinal direction and a rectangular cross-section, which is perpendicular to the longitudinal direction and has a width wc in a transversal direction and a height hc in a vertical direction (93), and wherein lc>wc and lc>hc.

### CROSS-REFERENCE TO RELATED APPLICATIONS

This application is a U.S. National Stage of International Application No. PCT/EP2023/061803 filed May 4, 2023, which claims the benefit of German Patent Application No. 102022111363.9, filed on May 6, 2022, each of which is hereby incorporated by reference in its entirety.

### FIELD OF THE INVENTION

Embodiments of the present invention are related to an inductive filter element. According to at least one embodiment, the inductive filter element can be a choke, preferably a broadband choke. For example, the inductive filter element can be implemented in a high-speed communication device. In particular, the inductive filter element can be used in industrial applications as well as in an automotive or medical environment.

### BACKGROUND OF THE INVENTION

Modern communication systems rely more and more on a high-speed transmission of data while being required to be lighter and smaller. Such structures often need a magnetic filter which has a high impedance over a broad frequency range. Providing electrical power and transmitting data to another device often require the use of the same line, which is realized in the so-called bias tee configuration. Such system that can transmit electrical power over a data line or signal channel is also known as asymmetric or unbalanced injection system and usually requires a compact and broadband high frequency filter.

For example, by using an unbalanced power injection system, a power-over-coaxial (PoC) system can be used to communicate between two devices and power them simultaneously. A set of inductors creates a multi-stage filter to achieve the desired AC blocking level. Using different impedance performances of multiple different inductors is a common method to achieve the desired bandwidth. Depending on the bandwidth needed, inductors with a high inductance value of around 10O to 150 μH can be used to fix the lower frequency impedance and inductors of some hundred nH can fix the higher frequency performance.

Thus, depending on the required bandwidth, a multi-stage filter formed by a filter network with two, three, four or even more inductor stages is usually used. Every inductor should be able to drive enough current to allow the power injection system to operate at the desired power level, working potentially at high temperature and with the lowest resistance possible to avoid too much power losses in the filter network. Additionally, to the need of meeting these requirements, such filter network needs a lot of space on the printed circuit board due to the size of each of the different inductors.

For example, prior art documents DE 10 2019 126 816 A1, DE 10 2008 044 845 A1, JP 2010-232 988 A, U.S. Pat. No. 10,701,693 B2 and US 2018/098324 A1 describe multi-stage filter networks.

The impedance peak of every inductor used in a multi-stage filter depends on the inductance value and the internal stray capacitance. However, the material, manufacturing concept and winding style of the coil as well as the enamel of the wire can change the internal stray capacitance of the implemented inductors. This variability of stray capacitance introduces problems in regard to the standardization of a unique filter for a desired bandwidth, since two similar inductors with the same inductance value can have different self-resonant frequencies (SRF) and different impedance curves. This problem is even more severe at higher frequency due to the greater influence of the stray capacitance versus the inductance value.

The existing state of the art offers several solutions to create the desired filter for high frequency in a power-over-signal configuration. The first solution available presents topologies using a bias-tee configuration with several inductors to obtain the desired bandwidth. As described before, this solution is used in unbalanced power injection systems like PoC systems. However, it is difficult to use this solution in balanced lines due to the asymmetric performance of the implemented two inductor networks with multiple stages mounted in every line. Here, changes of inductance value resulting from manufacturing tolerance introduce problems in regard to the high frequency mode conversion and return losses. However, if tolerances are tight, it is still possible to use such solution that is intended for asymmetric use in a symmetric case, which is then also referred to as power-over-dataline (PoDL).

At least one object of at least one embodiment is to provide an inductive filter element, preferably an inductive filter element having a broad bandwidth.

This object is achieved with the subject matter according to the independent claim. Further embodiments and configurations are subject matter of the dependent claims.

### SUMMARY OF THE INVENTION

According to at least one embodiment, an inductive filter element comprises a core element. The core element can comprise a first end region, a central region and a second end region arranged along a longitudinal direction, wherein the central region is arranged between the first end region and the second end region.

According to a further embodiment, the inductive filter element comprises a wire. The wire can comprise part that is formed as a winding on the central region of the core element and that is denoted here and in the following as winding part. The winding part forms the actual and only coil structure of the inductive filter element. In other words, the inductive filter element preferably comprises only one wire with only one winding part, so that the inductive filter element comprises only one coil structure.

According to a further embodiment, the central region of the core element has a length lc in the longitudinal direction. Preferably, lc is equal to or greater than 1 mm or equal to or greater than 5 mm and equal to or less than 15 mm. Furthermore, the core element has a rectangular cross-section that is perpendicular to the longitudinal direction. The cross-section is rectangular and has a width wc in a transversal direction and a height hc in a vertical direction, wherein each of the transversal direction and the vertical direction is preferably perpendicular to the longitudinal direction and the transversal direction is perpendicular to the vertical direction. Furthermore, lc>wc and lc>hc, i.e., the length of the core element is greater than both the width and the height. Preferably, lc/hc≥2, and lc/wc≥2 or even lc/wc≥3. Particularly preferably, 3≤lc/wc≤15 or 5≤lc/wc≤15 or 10≤lc/wc≤15, and 2≤lc/hc≤20 or 5≤lc/hc≤20 or 10≤lc/hc≤20 or 15≤lc/hc≤20.

Furthermore, the cross-section being rectangular can, in particular, mean that the cross-section at any position of the central region of the core element is rectangular. This can imply that the cross-section is square-shaped with wc=hc. Preferably, 1≤wc/hc≤5 or 2≤wc/hc≤5 or 3≤wc/hc≤5.

According to a further embodiment, the winding part is formed as a single-layer winding on the central region. In other words, the winding part has no wire part that is arranged, in either of the vertical and transversal direction, on another wire part. Preferably, the number or turns is substantially given by the length lc of the central region divided by the wire diameter, so that the wire is wound in a tight fashion. A single-layer winding can reduce the stray capacitance in comparison to coils with several winding layers wound on each other.

According to a further embodiment, the winding part of the wire is formed as a plurality of winding blocks that are arranged in the longitudinal direction one after the other and that are connected in series by transition parts of the wire. Each winding block can be formed of at least a single-layer winding, i.e., a winding with one layer, or a winding with equal to or less than 5 winding layers. Preferably, the length lwb of each winding block in the longitudinal direction is short compared to the length lc of the central region. For instance, lwb/lc≤0.5 or lwb/lc≤0.2 or lwb/lc≤0.1. Due to the short length of the winding blocks compared to the length of the central region and due to the few number of winding layers, each winding block can form a low-capacitive coil, so that all winding blocks sum up to a low-capacitive coil structure. Several winding layers per winding blocks can lead to a higher inductance value. The inductive filter element can preferably comprise a number of greater than or equal to 2 winding blocks and of less than or equal to 10 winding blocks. Each transition part can have a length lt along the longitudinal direction 91, wherein the length lt of the transition parts is preferably long enough so that the winding blocks are well separated from each other. Preferably, It is equal to or greater than 0.1 mm or equal to or greater than 0.2 mm or equal to or greater than 0.5 mm. Furthermore, lt is preferably equal to or less than 0.8 mm. Preferably, lt/lwb≥10. Furthermore, it is preferred that 20≤lc/lt≤150.

According to a further embodiment, the central region has first cross-section adjoining the first end region and a second cross-section adjoining the second end region. The first and second cross-section can be equal. In other words, the first cross-section can have a first area cs1 and the second cross-section can have a second area cs2 with cs1/cs2=1. In particular, any cross-section of the central region can be equal to the first and second cross-section, so that the central region can have a cuboid form. Alternatively, the first cross-section can be greater than the second cross-section, so that the central region of the core element can have a conical shape. This can mean that, with increasing distance from the first end region along the longitudinal direction, at least one of the height hc and the width wc decreases. For instance, at least one of the height hc and the width wc deceases linearly with increasing distance from the first end region. In particular, the first cross-section can have a first area cs1 and the second cross-section can have a second area cs2 with 1<cs1/cs2≤15 or 2≤cs1/cs2≤15 or 5≤cs1/cs2≤15 or even 10≤cs1/cs2≤15.

Preferably the first and second end regions have a similar shape and similar dimensions independent of the shape of the central region. In particular, a width of the first end region in the transversal direction can be equal to a width of the second end region in the transversal direction and a height of the first end region in the vertical direction can be equal to a height of the second end region in the vertical direction.

According to a further embodiment, the inductive filter element comprises a housing comprising a plastic material that completely encloses the core element and the wire. The housing can preferably be formed by a molding body comprising or consisting of a plastic material like an epoxy resin. Particularly preferably, the housing can be made from a high-temperature stable plastic material like, for instance, a material based on or consisting of liquid-crystal polymers (LCPs) and/or polyphenylene sulfide (PPS). The housing can consist of only one or more plastic materials without any filler material. Furthermore, the housing can comprise at least one filler material dispersed in the plastic material. Particularly preferably, the housing can comprise, as filler material, a magnetic material like magnetic particles or magnetic flakes which are dispersed in the plastic material. The magnetic material can comprise or be ferrite or metal powder, for instance.

According to preferred embodiments, the inductive filter element combines the concept of a long rectangular magnetic core element with a wire comprising a winding in only one layer or organized in several spatially separated winding blocks. To close the magnetic circuit, the magnetic core element is preferably covered with a housing formed by a molding body that preferably contains magnetic fillers which assure good shielding capabilities and a good performance to withstand high current. The inductive filter element can, in particular, be used and implemented in asymmetric current injection systems, as the described features provide a high self-resonant frequency while reducing the stray capacitance. The housing is preferably made of plastic and can contain magnetic fillers in order to provide a magnetic shielding and to improve the electrical parameters as a low DC resistance (RDC), a high inductance value and a good high frequency performance due to the low losses provided by the used material. In particular, good performance regarding scattering parameters as low return loss and low insertion loss make the component suitable for applications as PoC (Power over Coaxial) or LVDS (low-voltage differential signaling).

The inductive filter element described herein can form a broadband choke for high-speed communication devices and can provide several improvements over current state of the art inductive filters:
ultra-wide (broadband) frequency response, making the inductive filter element suitable for PoC or LVDS by covering a frequency range that is usually covered by a combination of two or three inductors;
good magnetic shielding using a housing over a magnetic core, the housing comprising or consisting of a plastic material in combination with magnetic materials;
a winding forming a coil structure with a low stray capacitance resulting in good high frequency performance;
a high permeability achieved by the magnetic materials, allowing for a low RDC while at the same time having a high saturation current.

According to further preferred embodiments, the inductive filter element comprises a magnetic core element with a conical shape. The coil structure formed by the winding part on the conical core element offers improved electrical

characteristics as even lower return and insertion loss and a lower stray capacitance that allows for an even higher self-resonant frequency while providing a high inductance and thus offering a broader frequency response.

Furthermore, the inductive filter element can also be used and implemented in symmetric current injection systems, since the inductive filter element descried herein can improve the performance achieved by traditional inductors used for a PoDL (Power over Data Line) system or similar systems. In particular, in such systems the use of filters with several filter stages can be challenging due to differences in the symmetric lines. This effect, which is introducing mode conversion in the scattering parameters (Scd11, Scd12, Scd21, Scd22, Sdc11, Sdc12, Sdc21, Sdc22) can be reduced by using the inductive filter element described herein, in combination with the further positive effects described before.

Further features, advantages and expediencies will become apparent from the following description of exemplary embodiments in conjunction with the figures.

### BRIEF DESCRIPTION OF THE DRAWINGS

FIG. 1A shows a schematic illustration of an inductive filter element according to an embodiment.

FIG. 1B shows a perspective view of the internal structure of the inductive filter element of FIG. 1A.

FIG. 1C shows an external perspective view of the inductive filter element of FIG. 1A.

FIG. 1D shows the core element of FIG. 1A with dimensions.

FIG. 1E shows a state of the not-yet-finished inductive filter element of FIG. 1A during manufacturing.

FIG. 2 shows a schematic illustration of an inductive filter element according to a further embodiment.

FIG. 3A shows a schematic illustration of an inductive filter element according to a further embodiment.

FIG. 3B shows a further schematic illustration of the inductive filter element of FIG. 3A.

FIG. 4A shows a schematic illustration of a core element of an inductive filter element according to a further embodiment.

FIGS. 4B shows a schematic illustration of a core element of an inductive filter element according to another embodiment.

FIG. 4C shows a schematic illustration of a core element of an inductive filter element according to yet a further embodiment.

FIG. 5 shows a schematic illustration of a circuit diagram of an exemplary PoC structure using the inductive filter element according to the embodiments described before.

FIG. 6 shows a typical AC blocking inductive filter that is used as a PoC filter shown in FIG. 5.

FIG. 7 shows a schematic illustration of an inductive filter element according to the embodiments described above that forms an inductive filter.

FIG. 8A shows first impedance curves according to the embodiments above.

FIG. 8B shows second impedance curves according to the embodiments above.

FIG. 8C shows third impedance curves according to the embodiments above.

FIG. 8D shows fourth impedance curves according to the embodiments above.

FIG. 8E shows fifth impedance curves according to the embodiments above.

In the figures, elements of the same design and/or function are identified by the same reference numerals. It is to be understood that the embodiments shown in the figures are illustrative representations and are not necessarily drawn to scale.

### DETAILED DESCRIPTION OF THE DRAWINGS

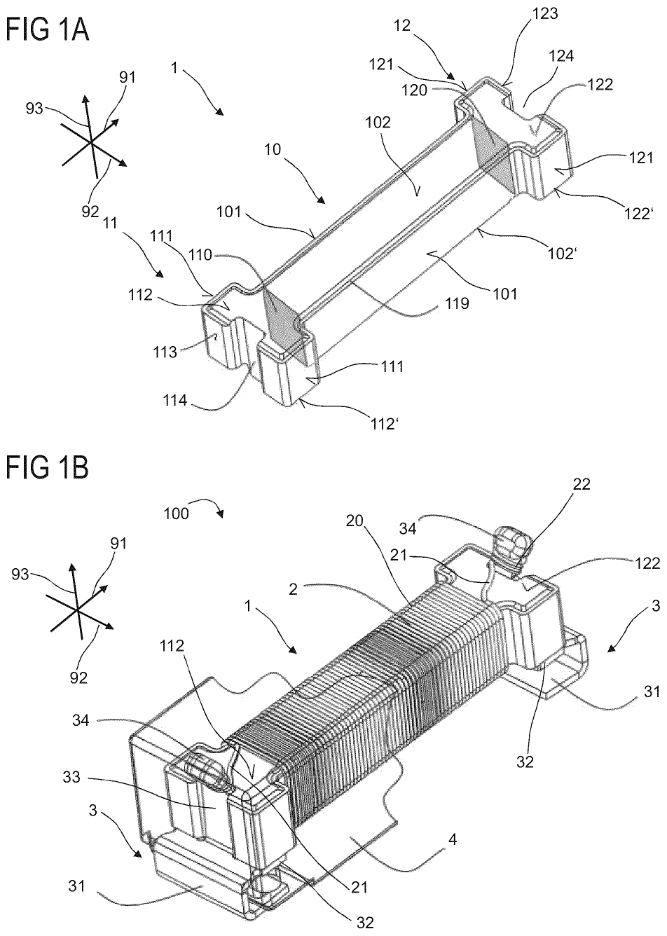

FIGS. 1A to 1E show in various views an inductive filter element 100 and several of its components according to an embodiment. The inductive filter element 100 comprises a core element 1, a wire 2 that forms a coil structure on the core element 1, electrical contact elements 3 and a housing 4.

FIG. 1A shows a perspective view of the core element 1 of the inductive filter element 100, FIG. 1B shows a perspective view of the internal structure of the inductive filter element 100, FIG. 1C shows an external perspective view of the inductive filter element 100, FIG. 1D shows the core element 1 with indicated dimensions, and FIG. 1E shows a state of the not-yet-finished inductive filter element 100 during the manufacturing. The following description equally applies to FIGS. 1A to 1E.

The core element 1, which can be made, for example, from ferrite and can be formed as a single piece, comprises a central region 10 between a first end region 11 and a second end region 12. Preferably, the first end region 11 and the second end region 12 directly adjoin the central region 10. Here and in the following, the main extension direction of the core element 1, i.e., the direction from the first end region 11 to the second end region 12, is denoted as longitudinal direction 91 as indicated in the figures. Thus, the first end region 11, the central region 10 and the second end region 12 arranged one after the other along the longitudinal direction 91.

Furthermore, a transversal direction 92 and a vertical direction 93 are indicated in the figures. When normally mounted on a mounting surface of a carrier as, for instance, a printed circuit board, the horizontal plane defined by the longitudinal direction 91 and the transversal direction 92 is arranged in parallel to the mounting surface of that carrier. The vertical direction 93 is arranged perpendicularly to the mounting surface. Dimensions along the longitudinal direction 91 are denoted as length, dimensions along the transversal direction 92 are denoted as width and dimensions along the vertical direction 93 are denoted as height. Thus, the inductive filter element 100 and the core element 1 each have a length in the longitudinal direction 91, a width in the transversal direction 92 and a height in the vertical direction 93, respectively.

The central region 10 of the core element 1 is delimited in the transversal direction 92 by lateral surfaces 101 arranged opposite to each other, so that the distance between the lateral surfaces 101 defines the width of the central region 10. Furthermore, the central region of the core element 1 is delimited in the vertical direction 93 by a top surface 102 and a bottom surface 102′ arranged opposite to each other, so that the distance between the top surface 102 and the bottom surface 102′ defines the height of the central region 10.

Similarly, the first end region 11 is delimited in the transversal direction 92 by lateral surfaces 111 arranged opposite to each other, wherein the distance between the lateral surfaces 111 defines the width of the first end region 11. The second end region 12 is delimited in the transversal direction 92 by lateral surfaces 121 arranged opposite to each other, wherein the distance between the lateral surfaces 121 defines the width of the second end region 11.

Furthermore, the first end region 11 is delimited in the vertical direction 93 by a top surface 112 and a bottom surface 112′ arranged opposite to each other, wherein the distance between the top surface 112 and the bottom surface 112′ defines the height of the first end region 11. The second end region 12 is delimited in the vertical direction 93 by a top surface 122 and a bottom surface 122′ arranged opposite to each other, wherein the distance between the top surface 122 and the bottom surface 122′ defines the height of the second end region 11.

As can be seen in FIGS. 1A and 1D, in the depicted embodiment the heights of the central region 10, the first end region 11 and the second end region 12 are equal to each other and are denoted as heights hc and h, respectively. The top surfaces 102, 112, 122 form a plane top surface of the core element 1, and the bottom surfaces 102′, 112′, 122′ form a plane bottom surface of the core element 1. The width wc of the central region 10 is smaller than the widths w of the first end region 11 and the second end region 12, wherein the widths of the first end region 11 and the second end region 12 are equal to each other, so that the core element 1 has a bone-like shape. Consequently, perpendicular to the longitudinal direction 91 the central region 10 has a cross-section with a height hc and width wc, which preferably can be equal to each other, so that central region 10 can have a square-shaped cross-section. Alternatively, the central region 10 can have a height hc and a width wc with hc/wc>1 or hc/wc<1, so that the central region 10 can have a rectangular cross-section. Preferably, 1≤wc/hc≤5. Furthermore, wc/hc can have a value as specified in the general part.

Adjoining the first end region 11, the central region 10 has a first cross-section 110, and adjoining the second end region 12, the central region 10 has a second cross section 120, wherein the first cross-section 110 and the second cross-section 120 are equal to each other in the shown embodiment.

In the longitudinal direction 91, the central region 10 has a length lc that is defined by the distance between the first cross-section 110 and the second cross-section 120. Furthermore, the first end region 11 has a first end surface 113 and the second end region 12 has a second end surface 123, wherein the first end surface 113 and the second end surface 123 delimit the core element 1 in the longitudinal direction 91. Thus, the distance between the first and surface 113 and the second end surface 123 define the length 1 of the core element 1. Preferably, 1.1≤lc/l≤1.5.

As can be seen in FIG. 1B, the wire 2 has a winding region 20 that is wound around the central region 10 to form, depending on the cross-section of the central part 10, a square-shaped or rectangular coil structure with a single-layer winding, i.e., the winding part 20 has no wire part that is arranged, in either of the vertical and transversal direction, on another wire part. In particular, the central region 10 is defined to be that part of the core element 1 on which the winding part 20 of the wire 2 is arranged, i.e., on which the coil windings are arranged. Thus, the actual coil structure formed by the winding part 20 starts at the first cross-section 110 and ends at the second cross-section 120. The wire 2 can comprise or consist of, for instance, one or more metals chosen from copper, nickel and chrome, can have an electrically insulating cover made from a polymer, a lacquer or an enamel, and can have a diameter of equal to or greater than 20 μm and equal to or less than 1 mm.

Preferably at least the edges 119 of the central region 10 between the lateral surfaces 101 and the top surface 102 as well as the bottom surface 102′ can be chamfered or rounded in order to facilitate a tight winding of the wire 2 around the central region 10. Thus, the expressions “rectangular” and “square” used throughout the description can include shapes with rounded or chamfered corners. Furthermore, even more or all edges of the core element 1 can be chamfered or rounded.

For electrically contacting the coil structure formed by the winding region 20 of the wire 2, the inductive filter element 100 has electrical contact elements 3 arranged at the first end region 11 and the second end region 12, respectively. The electrical contact elements 3 are formed from leadframe pieces 300 as shown in FIG. 1E. Each of the electrical contact elements 3 comprises an external contact region 31, support regions 32, a tongue region 33 that is arranged between the support regions 32, and a wire connection region 34 that provides a joining point for the wire 2. The tongue region 33 extends in the vertical direction, and the support regions 32 extend in the longitudinal direction. The external contact region 31 is bent to reach to an underside of the inductive filter element 100 so that the inductive filter element 100 can be soldered to the mounting surface of a carrier like a printed circuit board, for instance by a surface-mount technology (SMT). The core element 1 is arranged on the support regions 32 of the external contact elements 3, whereas the tongue regions 33 of the external contact elements 3 are guided in vertical direction along the first end surface 113 and the second end surface 123 of the core element 1, respectively. In order to fix each of the electrical contact elements 3 to the core 1, an adhesive can be used that is applied between the support regions 32 of each of the electrical contact elements 3 and the core element 1 and/or between the tongue region 33 of each of the electrical contact elements 3 and the core element 1. As can be seen in FIGS. 1A and 1B, the first end region 11 and the second end region 12 preferably have a groove 114, 124, respectively, in which the tongue regions 33 can be arranged. Thus, the grooves 114, 124 can be provided for easily mounting the external contact elements 3 to the core element 1. As can be seen in FIG. 1E, the leadframe pieces 300, which have the tongue region 33 already bent in the vertical direction 93, are attached and fixed to the core element 1. After connecting the wire 2 to the wire connection regions 34 of the leadframe pieces 300 a housing 4 as described below can be applied, the leadframe pieces 300 can be cut at the indicated dashed lines and the external contact regions 31 can be bent as described above to reach to an underside of the housing 4.

The wire 2 further comprises transition parts 21 and connection parts 22, wherein at each end of the winding part 20 a transition part 21 is located between the winding part 20 and one of the connection parts 22. The transitions parts 21 run across the top surfaces 112, 122 of the first and second end region 11, 12 to the wire connection regions 34 of the electrical contact elements 3. Each of the connection parts 22 is connected to a wire connection region 34, for instance by welding or soldering like laser welding, selective soldering or iron soldering in order to achieve a reliable connection between the wire 2 and the electrical contact elements 3.

Except for the external contact regions 31 of the electrical contact elements 3, all components of the inductive filter element 100 are arranged in a housing 4 that can, for example, be formed by a molding method like injection molding, compression molding or transfer molding. Thus, the housing 4 can preferably be formed by a molding body comprising or consisting of a plastic material like an epoxy resin. Particularly preferably, the housing 4 is made from a high-temperature stable plastic material like an LCP or PPS.

Furthermore, a magnetic material like ferrite particles or flakes can be dispersed in the plastic material of the housing 4. Preferably, a ratio of the amount of the magnetic material to the amount of plastic material in the housing 4 is equal to or greater than 40 mass-% and equal to or less than 95 mass-%. The magnetic material can form a magnetic filler for magnetic shielding in order to improve the electrical parameters like a lower DC resistance (RDC), a high inductance value and a good high frequency performance.

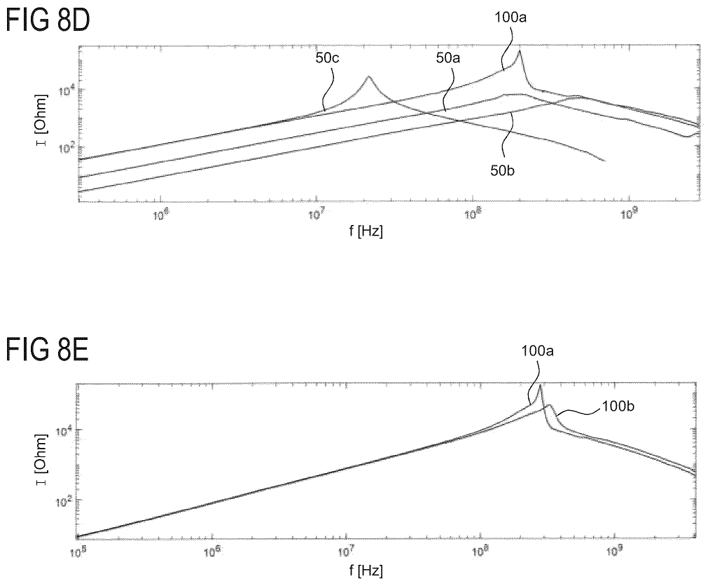

As described above, the dimensions of the coil structure formed by the winding part 20 are defined by the length lc, the width wc and the height hc of the central region. The winding part 20 forming the actual coil structure of the inductive filter element 100 is a long rectangular or square coil with lc>wc and lc>hc. Preferably, 3≤lc/wc≤15 and 2≤lc/hc≤20. Furthermore, each of lc/wc and lc/hc can have a value as specified in the general part. As described in connection with FIGS. 8A to 8E below, such coil dimensions in connection with a single-layer winding provide a low stray capacitance with a high inductance value and a high bandwidth.

The following figures show modifications and further developments of the inductive filter element 100. Thus, the following description substantially limited to the differences to the previous embodiment.

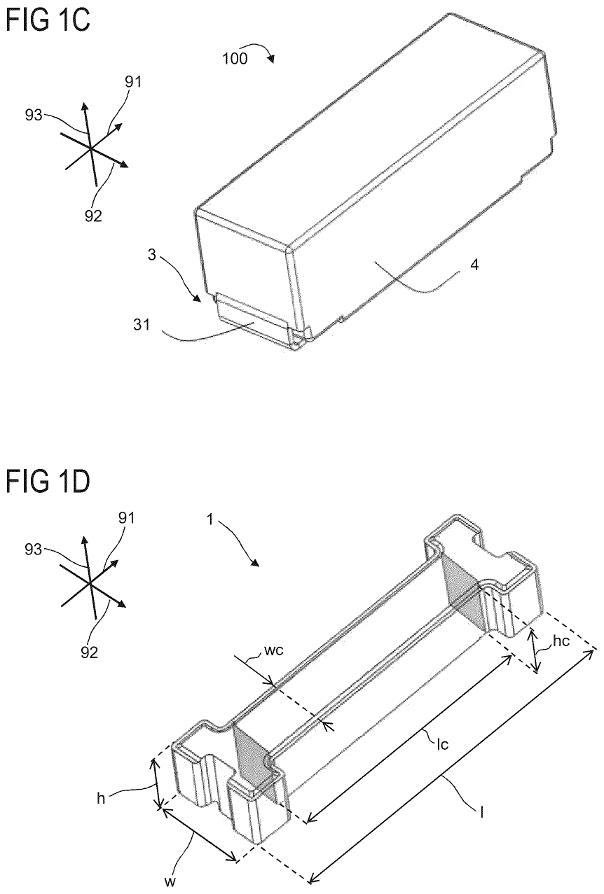

The inductive filter element 100 shown in FIG. 2 has a winding part 20 of the wire 2 with winding blocks 23, which are arranged spatially separated from each other on the central region 10 of the core element 1. Between the winding blocks 23 the winding part 20 of the wire 2 comprises transition parts 24 formed from a single wire part, preferably running over only one surface of the core element 1 like, for instance, the top surface 102 as shown or, alternatively, the bottom surface or one of the side surfaces. Thus, the winding part 20 of the wire 2 is formed of several coil structures formed by the winding blocks 23 that are connected in series only by the single-wire transition parts 24 of the wire 2.

The winding region 20 can preferably comprise at least two winding blocks 23 and not more than 10 winding blocks 23. As shown in FIG. 2, the winding part 20 can for example comprise 5 winding blocks 23.

Each of the winding blocks 23 can be embodied as a single-layer winding or can comprises several winding layers. For instance, as shown in FIG. 2, each winding block 23 can comprise three winding layers. Preferably, each winding block 23 is formed of at least a single-layer winding, i.e., a winding with one layer, or a winding with equal to or less than 5 winding layers. Preferably, the length lwb of each winding block 23 in the longitudinal direction 91 is short compared to the length lc of the central region 10. For instance, lwb/lc≤0.5 or lwb/lc≤0.2 or lwb/lc≤0.1. Due to the short length of the winding blocks 23 and the few number of winding layers, each winding block 23 can form a low-capacitive coil, so that all winding blocks 23 sum up to a low-capacitive coil structure. Due to the winding blocks 23, the inductive filter element 100 can achieve a higher inductance value. The inductive filter element 100 can preferably comprise a number of greater than or equal to 2 winding blocks 23 and of less than or equal to 10 winding blocks 23. As shown in FIG. 2, the inductive filter element 100 can for example have five winding blocks 23.

The length lt of the transition parts 24 along the longitudinal direction 91 is preferably long enough so that the winding blocks 23 are well separated from each other. Preferably, lt/lwb≥10. Furthermore, it is preferred that 20≤lc/lt≤150.

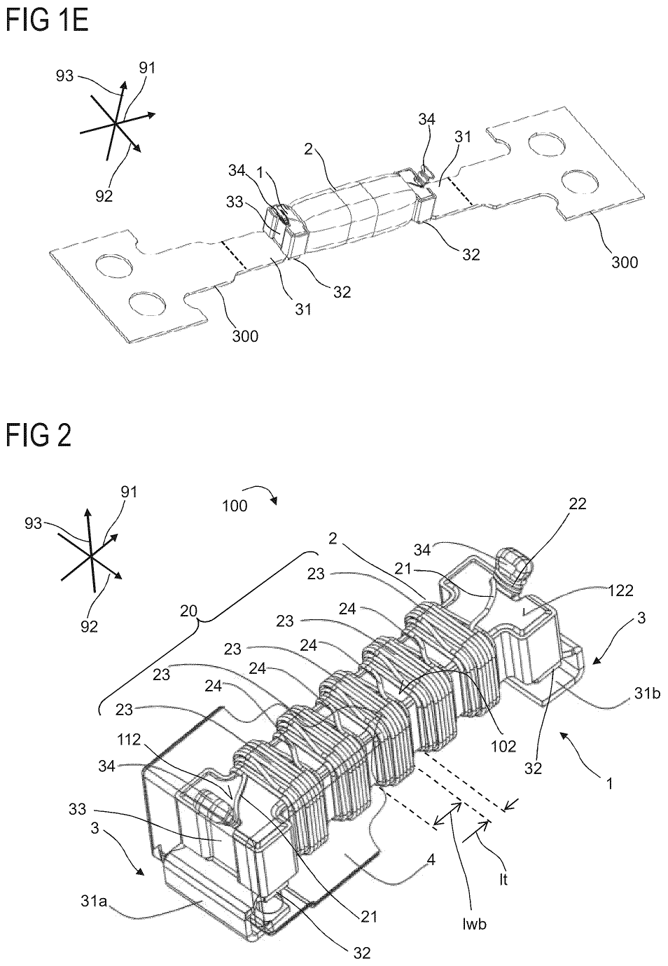

FIGS. 3A and 3B shown an embodiment of the inductive filter element 100 which, in contrast to the foregoing embodiments, has a conical core element 1. This means that the cross-section of the central region 10 decreases or increase with increasing distance from the first end region 11 or from the second end region 12. Accordingly, at least one of the width wc and the height hc of the central region 10 decreases with increasing distance from the first end region 11 or from the second end region 12.

As shown in FIGS. 3A and 3B, for example the width wc of the central region 10 can linearly decrease with increasing distance from the first end region 11. Accordingly, the central region 10 has a first cross-section 110 adjoining the first end region 11 and a second cross-section 120 adjoining the second end region 12, wherein the first cross-section 110 is greater than the second cross-section 120. The width of the first end region 11 is preferably still equal to the width of the second end region 12. The height hc of the central region 10 remains constant in this example. Due to the decreasing cross-section of the central region 10, the winding diameter of the winding part 20 of the wire 2 also decreases with increasing distance from the first end region 11. The conical shape can be applied in both directions of the core, although only one is shown in FIGS. 3A and 3B.

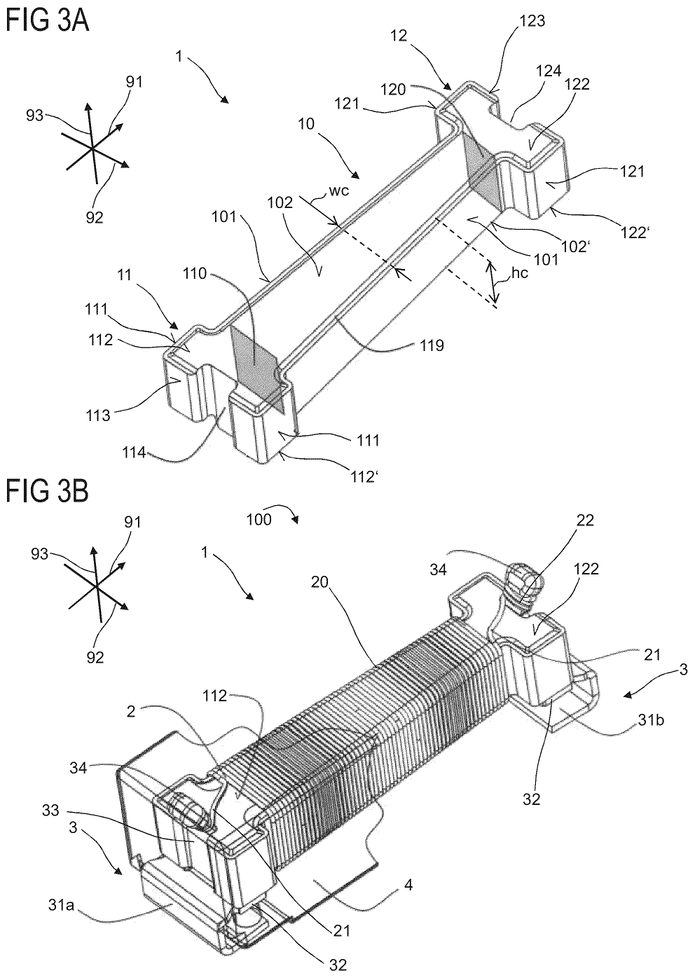

FIGS. 4A to 4C show further examples for the conical shape of the core 1 that can be combined with the conical shape shown in FIGS. 3A and 3B and/or with each other. FIG. 4A shows a linear decrease of the height hc of the central region 10 with increasing distance from the first end region 11. FIGS. 4B and 4C show a curved decrease of the width wc and of the height hc with increasing distance from the first end region 11.

Preferably, the decrease of the width wc and/or the height hc is chosen such that the ratio cs1/cs2 of the area cs1 of the first cross-section to the area cs2 of the second cross-section is greater than 1 and less than or equal to 15. Furthermore, cs1/cs2 can have a value as specified in the general part

The inductive filter element 100 according to embodiments described before can be used in any application requiring an inductive filter element. In particular, the inductive filter element 100 can be used in applications requiring a broadband inductive filter element as, for instance, an asymmetric injection system like a PoC structure.

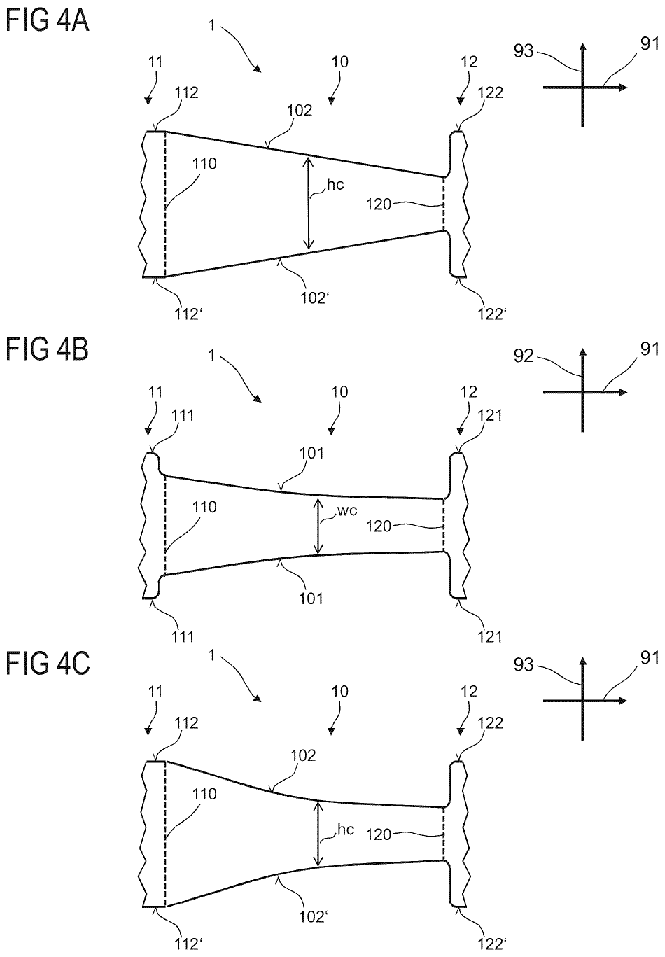

FIG. 5 shows a circuit diagram of a typical PoC structure as an example for a power injection application using the inductive filter element 100 according to the embodiments described before. Furthermore, the inductive filter element 100 can be used in other asymmetric or symmetric current injection systems.

The circuit depicted in FIG. 5 comprises a serializer 212a and a deserializer 212b, forming a so-called “SerDes”. The serializer 212a and deserializer 212b are AC-coupled on data-transmission lines through DC-blocking capacitors 213a, 213b, 213c, 213d and connected via a coaxial cable 216 providing the data transmission 217a as well as the power transmission 217b. Power is injected through an AC blocking inductive filter 215a by a power sourcing equipment (PSE) 211a and ejected by another AC blocking inductive filter 215b into the powered device (PD) 211b. Capacitors 214a and 214b are implemented to filter out AC noise coming from the transmission line as well as AC noise generated by either the PSE 211a or PD 211b. The DC blocking capacitors 213a, 213b, 213c, 213d together with the AC blocking inductive filters 215a, 215b form on each side of the coaxial cable 216a a so-called “bias tee” configuration.

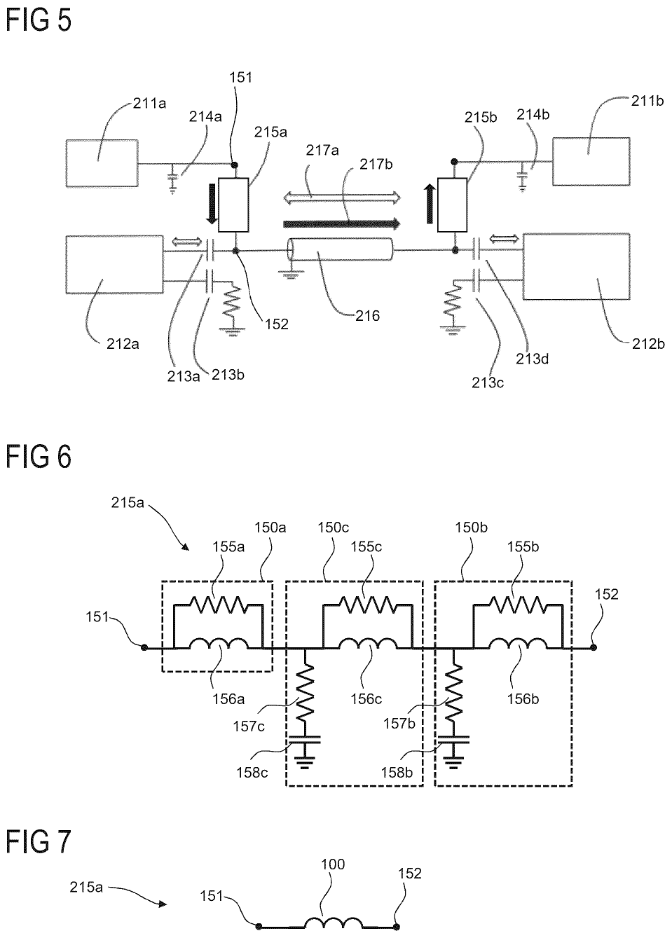

FIG. 6 shows a typical AC blocking inductive filter 215a that is used in the art as PoC filter between the nodes 151 and 152 in the circuit shown in FIG. 5. AC blocking inductive filter 215b can be embodied similarly.

In the circuit of FIG. 5 the RF path leads through the node 152 from the serializer 212a to the deserializer 212b, which are separated by the DC blocking capacitors. On the RF side of serializer 212b, there is also the DC signal present that is provided by PSE 211a and that is decoupled from the RF path by the AC blocking inductive filter 215a.

As shown in FIG. 6, the exemplary AC blocking inductive filter 215a comprises three filter stages 150a, 150b, 150c, wherein each filter stage 150a, 150b, 150c comprises a respective inductor 156a, 156b, 156c dampened by resistors 155a, 155b, 155c. For example, depending on the application, the resistor 155a is often omitted. For example, the stages 150b, 150c can comprise a respective additional resistor 157b, 157c together with a capacitor 158b, 158c to form T filters. However, resistors 157b, 157c and capacitors 158b, 158c are optional and can be omitted depending on the application.

A typical PoC filter structure at least comprises the first stage 155a and the second stage 155b or three stages 155a, 155b, 155c as shown in FIG. 6 or even further stages embodied like stage 155c to include in sum four or more stages.

Each of the inductors of the state-of-the-art filter structure has a certain bandwidth, so that the combination of the multiple filter stages creates the desired filter bandwidth and, thus, the required AC blocking level. Therefore, state-of-the-art filter structures forming broadband inductive filter solutions usually require a lot of space on a printed circuit board and are not cost effective.

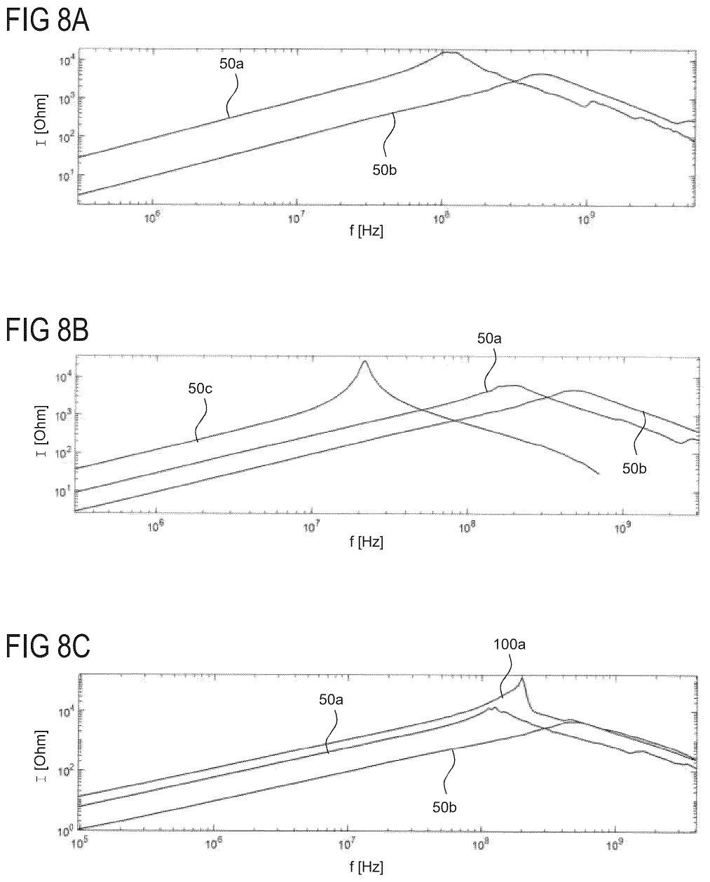

As indicated in FIG. 7, each of the whole state-of-the-art multi-stage filter structures forming the inductive filters in a circuit as the circuit shown in FIG. 5 can be replaced by the inductive filter element 100 according to the embodiments described above and, thus, by a single inductor element. Optionally, for example a damping resistor can be added in parallel to the inductive filter element 100. Consequently, instead of two complex multi-stage filter structures forming inductive filters 215a, 215b merely two inductive filter elements 100 can be used in the circuit of FIG. 5. Accordingly, a power injection system can comprise a power input side a power source on one side of a signal line, the signal line being, for instance, a data line or a coaxial cable, wherein an electrical DC power is coupled into the signal line through exactly one inductive filter element 100 as described herein. Furthermore, on the other side of the signal line, i.e., on the power output side, the electrical DC power is coupled out of the signal line through exactly one further inductive filter element 100 as described herein. The inductive filter element 100 on the power input side and the inductive filter element 100 on the power output side can be embodied similarly.

As explained in the following, the inductive filter element 100 provides a solution with a large bandwidth and an ultra-high self-resonance frequency. Additionally, the inductive filter element 100 can provide a good capability to withstand high DC currents and can save space on a printed circuit board and reduce the cost of the overall system.

In FIGS. 8A to 8E impedance curves of typical inductors used in multi-stage filter structures as well as impedances curves of inductive filter elements according to the description above are shown.

FIG. 8A shows the impedance curves 50a, 50b of the impedance I depending on the frequency f of a typical PoC filter circuit using two inductors. One inductor with a low inductance value, represented by curve 50b, adjusts the impedance for the high frequency performance, while a second inductor with a higher inductance value, represented by curve 50a, is used to adjust the lower frequency performance.

FIG. 8B shows the impedance curves 50a, 50b, 50c of a typical PoC filter circuit using three inductors. The first and second inductor, represented by curves 50a and 50b, are similar to the configuration of FIG. 8A, whereas the inductor with the lowest frequency performance, represented by curve 50c, requires a much higher inductance value, which leads to a filter structure with significantly increased cost and size.

For example, in order to create the desired impedance level over the shown frequency range, one can use three inductor coils with inductances of 100 μH, 5.6 μH and 220 nH, respectively. The different self-resonance frequencies (SRF) of the inductors cause the impedance peaks, wherein the SRF of an inductor is determined by the stray capacitance according to the formula SRF=1/[2π×(LC)^{1/2}] with L being the inductance value and C being the stray capacitance. Since the stray capacitance is significantly caused by the inter-winding capacitance, the best way to reduce the SRF is to reduce the inter-winding capacitance. In the inductive filter element 100 described above, a low stray capacitance with a high inductance value can be achieved with a rectangular core element with a winding region comprising a single-layer winding as described in connection with FIGS. 1A to 1E or comprising several well-separated winding blocks as described in connection with FIG. 2, since both measures significantly can reduce the inter-winding capacitance. A conically shaped core element as described in connection with FIGS. 3A and 3B that has a greater cross-section on one side of the core element and a smaller cross-section on the other side of the core element can help to even further reduce the inter-winding capacitance due to the smaller connection area between winding turns in the region of the smaller cross-section while, at the same time, achieving a better high frequency performance and eliminating resonance peaks.

In FIGS. 8C and 8D, the impedance curves 50a, 50b, 50c shown in FIGS. 8A and 8B are compared with the impedance curve 110a of the inductive filter element according to the present invention. In particular, the inductive filter element was embodied as described in connection with FIGS. 1A to 1E.

It can be clearly seen that in the high frequency range as well as in the low frequency range the inductive filter element shows an improved behavior, so that a performance increase can be obtained, while at the same time space on a printed circuit board and design effort are reduced as well costs, for instance caused by component sourcing, are reduced. Replacing a three-stage filter structure yields an even higher improvement compared to replacing two inductors by reducing even more in filter cost and size.

FIG. 8E shows the impedance curve 100a in comparison to the impedance curve 100b of an inductive filter element with a conically-shaped core element as described in connection with FIGS. 3A and 3B. It can be seen that the conical design leads to an even better high frequency performance, thereby increasing the bandwidth even more.

Alternatively or additionally to the features described in connection with the figures, the embodiments shown in the figures can comprise further features described in the general part of the description. Moreover, features and embodiments of the figures can be combined with each other, even if such combination is not explicitly described.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

### REFERENCE NUMERALS

1 core element
2 wire
3 electrical contact element
4 housing
10 central region
11 first end region
12 second end region
20 winding part
21 transition part
22 connection part
23 winding block
24 transition part
31, 31a, 31b external contact region
32 support region
33 tongue region
34 wire connection region
50a, 50b, 50c impedance curve
91 longitudinal direction
92 transversal direction
93 vertical direction
100 inductive filter element
100a, 100b impedance curve
101, 111, 121 lateral surface
102, 112, 122 top surface
102′, 112′, 122′ bottom surface
110 first cross-section
113 first end surface
114, 124 groove
119 edge
120 second cross-section
123 second end surface
151, 152 node
150a, 150b, 150c filter stage
155a, 155b, 155c resistor
156a, 156b, 156c inductor
157b, 157c resistor
158b, 158c capacitor
211a power sourcing equipment
211b powered device
212a serializer
212b deserializer
213a, 213b, 213c, 213d capacitor
214a, 214b capacitor
215a, 215b inductive filter
216 coaxial cable
217a data transmission
217b power transmission
300 leadframe piece

1-15. (canceled)

16. An inductive filter element, comprising
a core element including a first end region, a central region. and a second end region arranged along a longitudinal direction, the central region being arranged between the first end region and the second end region; and
a wire including a winding part that is formed as a winding on the central region of the core element,
wherein the central region of the core element has a length lc in the longitudinal direction and a rectangular cross-section being perpendicular to the longitudinal direction, the rectangular cross-section having a width wc in a transversal direction and a height hc in a vertical direction,
wherein lc>wc and lc>hc.

17. The inductive filter element according to claim 16, wherein 3≤lc/wc≤15 and wherein 2≤lc/hc≤20.

18. The inductive filter element according to claim 16, wherein 1≤hc/wc≤5.

19. The inductive filter element according to claim 16, wherein the winding part is formed as a single-layer winding on the central region.

20. The inductive filter element according to claim 16, wherein the winding part of the wire is formed as a plurality of winding blocks that are (i) arranged in the longitudinal direction one after the other and (ii) connected in series by transition parts of the wire.

21. The inductive filter element according to claim 20, wherein each winding block comprises equal to or less than 5 winding layers.

22. The inductive filter element according to claim 21, wherein each of the winding blocks has a length lwb along the longitudinal direction and 2≤lc/lwb≤10.

23. The inductive filter element according to claim 20, wherein each of the winding blocks has a length lwb along the longitudinal direction and 2≤lc/lwb≤10.

24. The inductive filter element according to claim 20, wherein each transition part between two adjacent winding blocks has a length lt along the longitudinal direction with 20≤lc/lt≤150.

25. The inductive filter element according to claim 16, wherein the central region has a first cross-section adjoining the first end region and a second cross-section adjoining the second end region, and wherein the first cross-section is greater than the second cross-section so as to form a conical shape in the central region of the core element.

26. The inductive filter element according to claim 25, wherein the first cross-section has a first area cs1 and the second cross-section has a second area cs2, and wherein 1<cs1/cs2≤15.

27. The inductive filter element according to claim 25, wherein, with increasing distance from the first end region along the longitudinal direction, at least one of the height hc and the width wc decreases.

28. The inductive filter element according to claim 27, wherein at least one of the height hc and the width wc decreases linearly with increasing distance from the first end region.

29. The inductive filter element according to claim 16, wherein a width of the first end region in the transversal direction is equal to a width of the second end region in the transversal direction and a height of the first end region in the vertical direction is equal to a height of the second end region in the vertical direction.

30. The inductive filter element according to claim 16, further comprising a housing comprised of a plastic material that completely encloses the core element and the wire.

31. The inductive filter element according to claim 30, wherein the housing comprises magnetic particles dispersed in the plastic material.
